(19) United States
(12) Patent Application Publication
(10) Pub. No.: US 2022/0363899 A1
(43) Pub. Date: Nov. 17, 2022

(54) MOULDING COMPOSITION CONTAINING POLYETHERAMIDE (PEA)

(71) Applicant: Evonik Operations GmbH, Essen (DE)

(72) Inventors: Franz-Erich BAUMANN, Duelmen (DE); Kathrin Salwiczek, Recklinghausen (DE)

(73) Assignee: Evonik Operations GmbH, Essen (DE)

(21) Appl. No.: 17/767,122

(22) PCT Filed: Sep. 30, 2020
(86) PCT No.: PCT/EP2020/077364

§ 371 Date: Apr. 7, 2022

(30) Foreign Application Priority Data
Oct. 11, 2019 (EP) 19202721.7

(51) Int. Cl. C08L 77/06; C08G 69/40

(52) U.S. Cl. CPC C08L 77/06; C08G 69/40

(57) ABSTRACT

A moulding composition contains polyetheramide (PEA) based on a subunit 1, made of at least one linear aliphatic diamine having 15 C atoms and at least one linear aliphatic or aromatic dicarboxylic acid having 6 to 14 C atoms. Furthermore, the PEA also contains a subunit 2, made of at least one polyether diamine having at least 2.3 C-5 atoms per ether oxygen and NH₂ groups at the chain ends. The moulding composition contains a maximum of 2.5% by weight of a rubber containing functional groups. The number of C atoms of at least one component of subunit 1 selected from diamine and dicarboxylic acid is at least 13, and the average molar mass number of subunit 2 is between 200 to 900 g/mol. A moulded object can be created from the moulding compound. The object can be a moulded part, a film, a bristle, a fiber, or a foam.

The present invention relates to a moulding compound comprising polyetheramide (PEA), to a moulded article produced therefrom and to the use thereof.

Polyetheramides (PEA) are block copolymers which are obtained by polycondensation of (oligo)polyamides, in particular acid-regulated polyamides, with alcohol-terminated or amino-terminated polyethers. Acid-regulated polyamides have carboxylic acid end groups in excess. Those skilled in the art refer to the polyamide blocks as hard blocks and the polyether blocks as soft blocks. The preparation thereof is known in principle. DE2712987A1 (U.S. Pat. No. 4,207,410) describes polyamide elastomers of this type, formed from lactams having 10-12 carbon atoms, dicarboxylic acids and polyether diols. The products obtainable according to this document are distinguished by long-lasting flexibility and ductility even at low temperatures, but they are already cloudy to opaque in mouldings of moderate layer thickness and, on longer-term storage at room temperature, are conspicuous due to surface deposits having a mildew-like appearance. Similarly structured polyamide elastomers, assembled from diamines having 6-20 carbon atoms, aliphatic or aromatic dicarboxylic acids and polyether diols, are known from EP0095893. Distinctive properties are increased heat distortion resistance and flexibility. No data regarding translucency of the mouldings and formation of deposits can be gathered from this document.

PA 11-based and PA 12-based PEA moulding compounds also stand out for negative reasons due to an opaque, cloudy appearance or formation of surface deposits. It was further observed that they exhibit a high level of deposits with simultaneously low translucency. Current moulding compounds are therefore of little suitability for applications.

US 2014/134371 describes transparent polyamide elastomers. These elastomers contain, inter alia, alkyl-substituted bis(aminocyclohexyl)methane and/or alkyl-substituted bis(aminocyclohexyl)propane. However, these compounds are toxic.

To this end, it was an object of the present invention to provide suitable moulding compounds, which are associated with a high translucency with low haze and freedom from deposits even over a relatively long period of time. In addition, they should be less toxic compared to alkyl-substituted bis(aminocyclohexyl)methane and/or alkyl-substituted bis(aminocyclohexyl)propane.

This object was achieved by a moulding compound comprising polyetheramide (PEA) based on a subunit 1, composed of at least one linear aliphatic diamine having 5 to 15 carbon atoms, preferably 6 to 10 carbon atoms, and at least one linear aliphatic dicarboxylic acid having 6 to 14 carbon atoms, preferably 12 to 14 carbon atoms, and on a subunit 2, composed of at least one polyether diamine having at least 2.3 carbon atoms per ether oxygen and NH₂ groups at the chain ends. The moulding compound contains at most 2.5% by weight of a rubber containing functional groups, based on the total weight of the moulding compound. The number of carbon atoms from at least one component of subunit 1 selected from diamine and dicarboxylic acid is at least 13 carbon atoms; the number-average molar mass of subunit 2 is 200 to 900 g/mol. Preferably, the molar mass of subunit 2 is 300 to 700 g/mol. Subunit 1 therefore forms the part generally referred to as the hard block, subunit 2 forms the soft block. The term linear is understood to mean that the carbon chain does not comprise any branches.

In a preferred embodiment, the number-average molar mass of subunit 1 is 250 to 4500 g/mol, particularly preferably 400 to 2500 g/mol, more particularly preferably 400 to 2000 g/mol, very particularly preferably 500 to 1600 g/mol. This leads to a material with higher translucency and simultaneously reduced formation of deposits.

The polyether diamine of the PEA is preferably selected from diaminated polypropylene glycol, diaminated polytetramethylene glycol, copolyethers of these and mixtures thereof.

The sum total of the carbon atoms from diamine and dicarboxylic acid in the PEA is 19 to 24.

Suitable polyamides of subunit 1 are selected for example from 6,13, 6,14, 10,14.

The moulding compound according to the invention contains at most 2.5% by weight of a rubber containing functional groups. Preference is given to at most 0.5% by weight and preferably at most 0.1% by weight being present. it is particularly preferable for the rubber not to be present. Such rubbers are described for example in EP-A-1518901.

The moulding compound according to the invention preferably contains at most 8 mol% of alkyl-substituted bis(aminocyclohexyl)alkane derivatives selected from alkyl-substituted bis(aminocyclo-hexyl)methane and alkyl-substituted bis(aminocyclohexyl)propane. The figure relates to the sum total of the molar amounts of linear aliphatic diamines of subunit 1 and alkyl-substituted bis(aminocyclohexyl)alkane derivatives. Preference is given to at most 5 mol% and particular preference is given to at most 2 mol%. In a very particularly preferred embodiment, no bis(aminocyclohexyl)methane and no bis(aminocyclohexyl)propane are present in the moulding compound.

The invention further provides a moulded article produced from the moulding compound according to the invention. The moulded article is preferably a moulding, a film, a bristle, a fibre or a foam. The moulded article may for example be produced by compression-moulding, foaming, extrusion, coextrusion, blow moulding, 3D blow moulding, coextrusion blow moulding, coextrusion 3D blow moulding, coextrusion suction blow moulding or injection moulding. Processes of this kind are known to those skilled in the art.

The invention further provides for the use of the moulded article according to the invention, which may for example be used as a fibre composite component, shoe sole, top sheets for skis or snow-boards, line for media, spectacle frame, design article, sealing material, body protection, insulating material or housing parts provided with a film.

### EXAMPLES

### Preparation of the polyetherarnides (PEA)

General procedure for preparing the PEA:

The feed tank of a 100 | double-tank polycondensation installation, provided with an anchor stirrer, is successively initially charged at below 60° C. with the diamine, 10% of the mass thereof of deionized (DI) water, dicarboxylic acid and the polyether diamine (ELASTAMIN ® RP405 or RP 2005). PPG diamine forms subunit 2. Based on the polyether diamine, 0.1% IRGANOX® 1098 (BASF SE) is added as process stabilizer. Based on the total solids content, 0.3% 50%-strength hypophosphorous acid is added as catalyst. After repeated pressure inertization with N₂, the tank contents are heated to 180° C.-190° C.; at 160° C. the stirrer is engaged. The starting materials are stirred for 1 hour and are thereafter transferred into the polycondensation reactor, provided with a helical stirrer and torque recorder. After pressure has been equalized between the two vessels, the reactor valve is closed and the contents are brought up to 228° C.-232° C. within 6 hours while stirring at 25 rpm. Upon reaching 21 bar autogenous pressure—normally between 210° C. and 215°C. internal temperature—a two-hour pressure maintenance stage is observed, after which depressurization is performed continuously to atmospheric pressure while further raising the temperature. After 3-4 hours at atmospheric pressure—provided that the desired final torque has not yet been reached — re-duced pressure is applied within 5 hours until a final reduced pressure of 40-60 mbar is reached. Further stirring is performed under these conditions until the desired final torque is reached. The melt is extruded into a water bath, pelletized and dried at 70° C.-90° C. in a tumble dryer to a water content <0.1%.

Molar ratio of subunit 1 to subunit 2: 100:103

The PEA prepared are summarized in Table 1 which follows. The molar mass of subunit 1 results from the molar ratio of the dicarboxylic acid used and the diamine.

TABLE 1
PEA prepared

| | | | | Initial | Mn | | | | |
|---|---|---|---|---|---|---|---|---|---|
| | | | | weight of | of | | | | |
| Ex- | | Initial | Dicar- | dicar- | sub- | | | Diamine | |
| peri- | Dia- | weight of | boxylic | boxylic | unit | Dia- | | initial | |
| ment | mine | diamine kg | acid | acid kg | 1 | mine | Mn of diamine | weight kg | Product |
| 1 | 6 | 13 721.10 | 13 | 31 278.90 | 4096 | A | 405 | 4150.13 | PEA 6, 13 |
| 2 | 6 | 13 082.82 | 13 | 31 917.18 | 2268 | A | 405 | 7531.53 | PEA 6, 13 |
| 3 | 6 | 12 355.98 | 13 | 32 644.02 | 1509 | A | 405 | 11 382.08 | PEA 6, 13 |
| 4 | 6 | 11 491.36 | 13 | 33 508.64 | 1083 | A | 405 | 15 962.53 | PEA 6, 13 |
| 5 | 6 | 12 507.91 | 14 | 32 492.09 | 2268 | A | 405 | 7564.33 | PEA 6, 14 |
| 6 | 6 | 11 764.68 | 14 | 33 235.32 | 1509 | A | 405 | 11 432.78 | PEA 6, 14 |
| 7 | 6 | 10 880.37 | 14 | 34 119.63 | 1083 | A | 405 | 16 035.53 | PEA 6, 14 |
| 8 | 10 | 16 106.96 | 14 | 28 893.04 | 2268 | A | 405 | 7658.17 | PEA 10, 14 |
| 9 | 10 | 13 988.53 | 14 | 31 011.47 | 1083 | A | 405 | 16 208.31 | PEA 10, 14 |
| 10 | 10 | 10 634.92 | 14 | 34 365.08 | 600 | A | 405 | 29 743.73 | PEA 10, 14 |
| 11 | 10 | 14 317.30 | 14 | 25 682.70 | 2268 | A | 405 + 2005 (1:1)* | 5485.47 + | PEA 10, 14 |
| | | | | | | | | 5548 | |
| 12 | 10 | 9325.69 | 14 | 20 674.31 | 1083 | A | 405 + 2005 (1:1)* | 8707.37 + | PEA 10, 14 |
| | | | | | | | | 8004 | |
| 13 | 10 | 9325.69 | 14 | 20 674.31 | 1083 | A | 405 + 2005 (2:1)* | 9525.66 + | PEA 10, 14 |
| | | | | | | | | 4764 | |
| 14 | 6 | 3039 | 13 | 9262 | 1083 | B | 405 | 4112 | PEA 6, 13 |
| | | | | | | (95:5) | | | |
| 15 | 6 | 3039 | 13 | 9262 | 1083 | B | 405 | 4112 | PEA 6, 13 |
| | | | | | | (95:5) | | | |
| 16 | 6 | 2859 | 13 | 9262 | 1083 | B | 405 | 4112 | PEA 6, 13 |
| | | | | | | (90:10) | | | |
| 17 | 6 | 3491 | 13 | 9709 | 1509 | B | 405 | 3155 | PEA 6, 13 |
| | | | | | | (95:5) | | | |
| 18 | 6 | 3124 | 13 | 9709 | 1509 | B | 405 | 3155 | PEA 6, 13 |
| | | | | | | (85:15) | | | |

All initial weights in kg,
*mass ratio, corrected to equivalent weights of the polyether diamines
diamine 6 = hexamethylenediamine
diamine 10 = 1,10-decamethylenediamine
dicarboxylic acid 13 = brassylic acid
dicarboxylic acid 14 = 1,14-tetradecanedioic acid
dicarboxylic acid 18 = 1,18-octadecanedioic acid
Diamine A: polypropylene glycol diamine
Diamine B: hexamethylenediamine/bis(4-amino-3-methyicyciohexyl)methane, ratio in mol-%

The PEA prepared were investigated in respect of appearance of the extrudate, relative viscosity ηᵣₑₗ and melting point Tm (cf. Table 2). Appearance of the extrudate: visual inspection. Viscosity: ISO 307. Tm: DSC, second heating step to ISO 11357.

TABLE 2
Properties of the PEA prepared

| | | | | Tm (DSC, |
|---|---|---|---|---|
| | | Appearance | | second |
| Experi- | | of the | | heating |
| ment | Product | extrudate | ηᵣₑₗ | step) |
| 1 | PEA 6, 13 | Transparent | 1.63 | 189 |
| 2 | PEA 6, 13 | Transparent | 1.85 | 187 |
| 3 | PEA 6, 13 | Transparent | 1.62 | 182 |
| 4 | PEA 6, 13 | Transparent | 1.86 | 178 |
| 5 | PEA 6, 14 | Transparent | 1.80 | 191 |
| 6 | PEA 6, 14 | Transparent | 1.73 | 185 |
| 7 | PEA 6, 14 | Transparent | 1.78 | 180 |
| 8 | PEA 10, 14 | Transparent | 1.81 | 184 |
| 9 | PEA 10, 14 | Transparent | 1.76 | 174 |
| 10 | PEA 10, 14 | Transparent | 1.63 | 141 |
| 11 | PEA 10, 14 | opaque | 1.76 | 174 |
| 12 | PEA 10, 14 | opaque | 1.66 | 169 |
| 13 | PEA 10, 14 | Milky/cloudy | 1.62 | 168 |
| 14 | PEA 6, 13 | Transparent | 1.64 | 175 |
| 15 | PEA 6, 13 | Transparent | 1.68 | 174 |
| 16 | PEA 6, 13 | Transparent | 1.74 | 170 |
| 17 | PEA 6, 13 | Transparent | 1.72 | 180 |
| 18 | PEA 6, 13 | Transparent | 1.79 | 173 |

### Testing of the polyetheramides prepared

Deposit test

Injection-moulded plaques measuring 60 mm×60 mm×2 mm were produced from the polyetheramides as test specimens. The formation of deposits was ascertained after the test specimen had been stored for a test period of 10 days in a closed vessel with water vapour saturation at 75° C. Deposits were assessed visually using a four-point scale (from 0-3, where 0=free of deposits and 3=subject to heavy deposits).

Determination of translucency

The translucency of the aforementioned test specimens was ascertained visually. In this case the following evaluation was used (in decreasing order of translucency):

0=translucent ++

1=translucent +

2=translucent 0

3=opaque/milky, translucent 0

4=opaque/milky, translucent −

5=milky-white.

Determination of haze value

The haze value specifies the illumination through an article in transmitted light. The haze value is measured here by means of the 60×60×2 mm plaques to ASTM standard D 1003 using a Konica-Minolta CM-3600d. Where the specimen was opaque/milky or even milky-white, determination of the haze value was usually dispensed with.

TABLE 3
Test results of PEA 6, 13-405 (according to the invention)

| | | | | | | Translu- |
|---|---|---|---|---|---|---|
| Experi- | | Mn of sub- | Mn of | Deposit | Haze | cency |
| ment | Product | unit 1 | subunit 2 | test | value | (visual) |
| 1 | PEA 6, 13 | 4096 | 405 | 0 | 60.3 | 0-1 |
| 2 | PEA 6, 13 | 2268 | 405 | 0 | 56.6 | 0-1 |
| 3 | PEA 6, 13 | 1509 | 405 | 0 | 48.1 | 0-1 |
| 4 | PEA 6, 13 | 1083 | 405 | 0 | 42.3 | 0-1 |

The PEA 6, 13 specimens exhibit no deposits with a high translucency and low haze value.

TABLE 4
Test results of PEA 6, 14-405 (according to the invention)

| | | | | | | Translu- |
|---|---|---|---|---|---|---|
| Experi- | | Mn of sub- | Mn of sub- | Deposit | Haze | cency |
| ment | Product | unit 1 | unit 2 | test | value | (visual) |
| 5 | PEA 6, 14 | 2268 | 405 | 1 | 53.8 | 1 |
| 6 | PEA 6, 14 | 1509 | 405 | 0-1 | 41.9 | 0 |
| 7 | PEA 6, 14 | 1083 | 405 | 1 | 29.8 | 0 |

The PEA 6, 14 test specimens are transparent with low haze. They are either free of deposits or exhibit small amounts of deposits.

TABLE 5
Test results of PEA 10, 14-405 (according to the invention)

| | | | | | | Translu- |
|---|---|---|---|---|---|---|
| Experi- | | Mn of sub- | Mn of sub- | Deposit | Haze | cency |
| ment | Product | unit 1 | unit 2 | test | value | (visual) |
| 8 | PEA 10, 14 | 2268 | 405 | 1 | 20.7 | 0 |
| 9 | PEA 10, 14 | 1083 | 405 | 0-1 | 18.5 | 0 |
| 10 | PEA 10, 14 | 600 | 405 | 0 | 7.9 | 0 |

PEA 10, 14 specimens display a high translucency and pass the deposit test.

TABLE 6
Test results of PEA 10, 14-405/2005 (not according to the invention)

| | | Mn | | | | Translu- |
|---|---|---|---|---|---|---|
| Experi- | | of sub- | Mn of sub- | Deposit | Haze | cency |
| ment | Product | unit 1 | unit 2 | test | value | (visual) |
| 11 | PEA 10, 14 | 2268 | 405 + 2005 | 0-1 | 99.2 | 4 |
| | | | (1:1)* | | | |
| 12 | PEA 10, 14 | 1083 | 405 + 2005 | 1 | 102 | 4 |
| | | | (1:1)* | | | |
| 13 | PEA 10, 14 | 1083 | 405 + 2005 | 0-1 | 93.4 | 4 |
| | | | (2:1)* | | | |

*mass ratio

PEA 10,14 having a subunit containing monomers having a high molar mass of 2005 g/mol display small amounts, if any, of deposits. However, the test specimens are milky-white.

TABLE 7
Test results of PEA 6, 13 containing diamine B
(not according to the invention)

| | | | | | | Translu- |
|---|---|---|---|---|---|---|
| Experi- | | Mn of sub- | Mn of | Deposit | Haze | cency |
| ment | Product | unit 1 | subunit 2 | test | value | (visual) |
| 14 | PEA 6, 13 | 1083 | 405 | 2 | 24.5 | 0 |
| 15 | PEA 6, 13 | 1083 | 405 | 2 | 33.4 | 0 |
| 16 | PEA 6, 13 | 1083 | 405 | 1 | 21.5 | 0 |
| 17 | PEA 6, 13 | 1509 | 405 | 3 | 32.8 | 0 |
| 18 | PEA 6, 13 | 1509 | 405 | 1-2 | 12.6 | 0 |

The shaped bodies containing diamine B which were obtained were transparent, but they exhibited deposits. in addition, there were demoulding problems during the injection moulding. Furthermore, the test bars were semi-circular in form (along the longitudinal axis).

1 A moulding compound, comprising:
polyetheramide (PEA) based on
a subunit 1, composed of at least one linear aliphatic diamine having 5 to 15 carbon atoms and at least one linear aliphatic or aromatic dicarboxylic acid having 6 to 14 carbon atoms, and
a subunit 2, composed of at least one polyether diamine having at least 2.3 carbon atoms per ether oxygen and NH₂ groups at the chain ends; and at most 2.5% by weight of a rubber containing functional groups,
wherein a number of carbon atoms from at least one of the at least one linear aliphatic diamine and the at least one linear aliphatic or aromatic dicarboxylic acid is at least 13 carbon atoms, and
a number-average molar mass of subunit is 200 to 900 g/mol.

2 The moulding compound according to claim 1, wherein the number-average molar mass of subunit 2 is 300 to 700 glmol.

3 The moulding compound according to claim 1, wherein a number-average molar mass of subunit 1 is 250 to 4500 g/mol.

4 The moulding compound according to claim 3, wherein the number-average molar mass of subunit 1 is 400 to 2500 g/mol.

5 The moulding compound according to claim 1, wherein the at least one polyether diamine is selected from the group consisting of diaminated polypropylene glycol, diaminated polytetramethylene glycol, a copolyether of these, and a mixture thereof.

6 The moulding compound according to claim 1, wherein a sum total of carbon atoms from the at least one linear aliphatic diamine and the at least one linear aliphatic or aromatic dicarboxylic acid is 19-24.

7 The moulding compound according to claim 1, wherein subunit 1 is selected from the group consisting of nylon-6,13, nylon-6,14, and nylon-10,14.

8 The moulding compound according to claim 1, wherein a proportion of rubber is at most 0.5% by weight.

9 The moulding compound according to claim 1, wherein the at least one linear aliphatic diamine contains 6 to 10 carbon atoms.

10 The moulding compound according to claim 1, wherein the at least one linear aliphatic or aromatic dicarboxylic acid contains 12 to 14 carbon atoms.

11 A moulded article produced from the moulding compound according to any of the preceding claims claim 1.

12 The moulded article according to claim 11, wherein the moulded, article is a moulding, a film, a bristle, a fibre or a foam.

13 The moulded article according to claim 11, produced by compression-moulding, foaming, extrusion, coextrusion, blow moulding, 3D blow moulding, coextrusion blow moulding, coextrusion 3D blow moulding, coextrusion suction blow moulding or injection moulding.

14 The moulded article according to claim 11, wherein the moulded article is a fibre composite component, a shoe sole, a top sheet for skis or snowboards, a line for media, a spectacle frame, a design article, a sealing material, a body protection, an insulating material, or a housing part provided with a film.

8. : The moulding compound according to claim 8, wherein the proportion of rubber is at most 0.1% by weight.
